(19) United States
(12) Patent Application Publication
(10) Pub. No.: US 2008/0003366 A1
(43) Pub. Date: Jan. 3, 2008

(54) Method of forming a conducting layer on a conducting and non-conducting substrate

(76) Inventors: Valery M. Dubin, Portland, OR (US); Ramanan V. Chebiam, Hillsboro, OR (US); Michael Goldstein, Sunnyvale, CA (US); Toru Imori, Ibaraki (JP)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/479,535

(22) Filed: Jun. 30, 2006

(51) Int. Cl. B05D 1/40

(52) U.S. Cl. 427/331; 427/349

(57) ABSTRACT

A method of processing a substrate is described. A coupling agent and a metal ion solution are applied to the substrate. An activating solution is applied to activate metal ions of the metal ion solution to create a metal film out of the ions. Atoms of the metal film are used to catalyze a metal of a base metal solution to form a metal layer. The metal layer can be used as a seed layer for electroplating purposes.

### BACKGROUND OF THE INVENTION

1). Field of the Invention

Embodiments of this invention relate generally to a method of processing a substrate, and more particularly to a method of forming a uniform thin film out of the liquid phase.

2). Discussion of Related Art

Electroplating has been used to form Cu interconnects and other structures for integrated circuit applications. The electroplating process requires a uniform, continuous, conformal metal layer acting as the seed for gap fill. The major issues with physical vapor deposition or chemical vapor deposition used today for seed preparation are the conformality and especially the pinch-off at the trench opening. With the shrinking dimension of the line and the increased aspect ratio these methods may become obsolete.

Other metal deposition techniques for forming a seed layer have been developed as alternatives to electroplating. One technique, known as electroless plating, involves depositing metal on substrates using chemical rather than electrical means. In order for this technique to work, the substrate must first be coated with an activation layer. Then, a chemical process is performed which allows for the subsequent deposition of metal from solution using the activation layer. Electroless films are uniform and have a slow rate of deposition.

### BRIEF DESCRIPTION OF THE DRAWINGS

Embodiments of the invention are described by way of examples with reference to the accompanying drawings wherein:

FIG. 1 is a flow chart illustrating a method of processing a substrate according to an embodiment of the invention;

FIG. 2 shows cross-sectional side views during the processing of the substrate;

FIG. 3 illustrates a molecule of a coupling agent that is used in the process of FIG. 2;

FIG. 4 illustrates the molecule of FIG. 3 after an atom of the molecule catalyzes a metal to form a layer;

FIG. 5 is a cross-sectional side view illustrating how a film that is formed in the process of FIG. 2 can be used as a seed layer when plating a metal structure of a microelectronic circuit; and

FIG. 6 is a block diagram of a computer system in which the structure of FIG. 5 may reside.

### DETAILED DESCRIPTION OF THE INVENTION

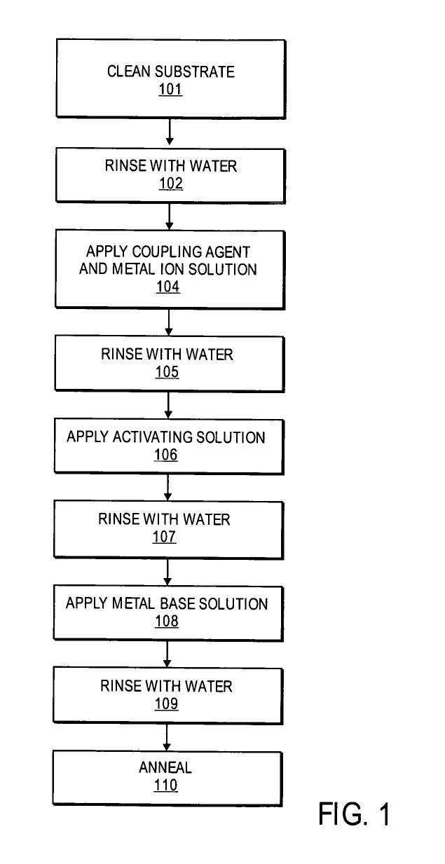

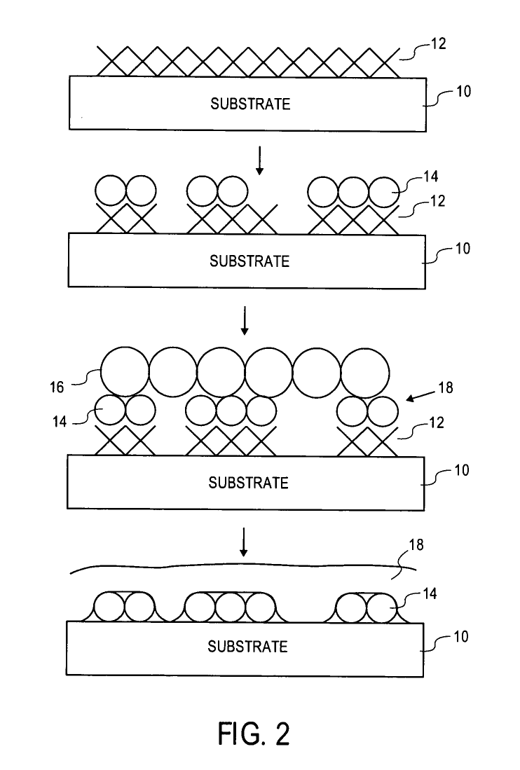

FIGS. 1 and 2 illustrate a method of processing a substrate, according to an embodiment of the invention. The method utilizes aqueous phase materials to deposit a conformal, uniform layer having a typical thickness between 1 nm and 10 nm. The layer is formed at a low temperature of between 50° C. and 70° C. and is annealed at a relatively low temperature of approximately less than 350° C.

At block 101, a substrate is cleaned. Cleaning of the substrate functionalizes its surface with OH-groups. A cleaner solution normally contains surfactants, phosphates, or carbonates in an alkaline medium. Such a cleaner solution makes a substrate more hydrophilic by functionalizing OH-groups.

At block 102, the substrate is rinsed with water. The water removes the remaining cleaner solution and thereby exposes the functionalized OH-groups.

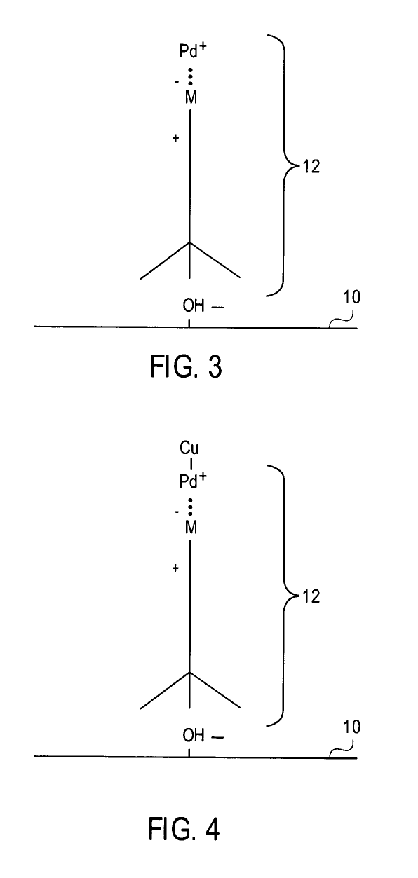

At block 104, a coupling agent and a metal ion solution are applied to the substrate. The substrate is indicated in FIG. 2 with reference numeral 10 and the coupling agent and metal ion solution are indicated with reference numeral 12. The coupling agent is preferably an amino silane. An amino silane such as imidizole silane is a good coupling agent. A chemical bond is formed between the coupling agent and an ion. An example of such a molecule is illustrated in FIG. 3, wherein the ion is Pd+. The metal ion solution is applied at a temperature of between 50° C. and 70° C. At block 105, the substrate is again rinsed with water.

At block 106, an activating solution is applied. The activating solution partially reduces Pd2+ to Pd. The activating solution contains reducing agents such as hypophosphorus acid or dimethylamine borane. The activating solution is applied at a temperature of between 50° C. and 70° C. At block 107, the substrate is again rinsed with water.

At block 108, a metal base solution is applied. The metal base solution includes a metal that is catalyzed by the metal of the metal film of the atoms 14. The metal from the metal base solution is represented as reference numeral 16 in FIG. 2 and as Cu in FIG. 4. The manner according to which Pd acts as a catalyst will be well understood by those skilled in the art of electroless plating. The metal 16 continues to grow to form a continuous metal layer 18. A composite layer is formed that includes the Pd atoms 14 and the Cu layer 18. The metal base solution is applied at a temperature between 50° C. and 70° C. At block 109, the substrate is again rinsed with water.

The process described with reference to blocks 104, 106, and 108 is a low-temperature process. The coupling agent, the activating solution, and the metal base solution are applied in liquid phase at a temperature of between 50° C. and 70° C.

At block 110, the entire structure, including the coupling agent 12, atoms 14, and metal 16, is annealed. Annealing is carried out at a temperature below 350° C., typically at a temperature of approximately 300° C. The layer 18 includes the atoms 14 and a continuous layer of the metal 16. Annealing also improves adhesion between the layer 18 and the substrate 10.

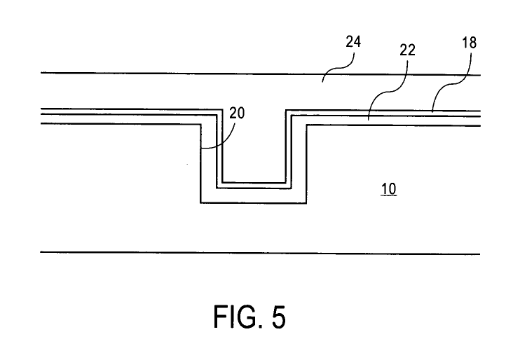

As illustrated in FIG. 5, the process for forming the layer 18 can be used for the formation of a metal seed layer in an electroplating plating operation. A trench 20 is formed in a silicon or interlayer dielectric layer of a substrate 10. A barrier layer 22 is then formed on the substrate 10, including on sidewalls and on a base of the trench 20. The barrier layer 22 is typically made of a metal such as tantalum or an alloy such as tantalum nitrate. The layer 18 forms a seed layer that covers the barrier layer 22. The layer 18 can then act as a seed layer for purposes of plating a structural metal layer 24 on the layer 18. The seed layer 18 and the structural metal layer 24 are typically formed of the same metal, such as copper.

The structural metal layer 24 is subsequently planarized in a chemical-mechanical polishing operation, which also removes upper proportions of the layer 18 and the barrier layer 22. A metal structure remains in the trench 20. The metal structure may be a plug, a via, or a metal line in the trench 20.

The substrate 10 and the metal structure formed in the trench 20 form a microelectronic structure that forms part of a microelectronic circuit. Such a microelectronic circuit may, for example, be a processor or memory of a computer.

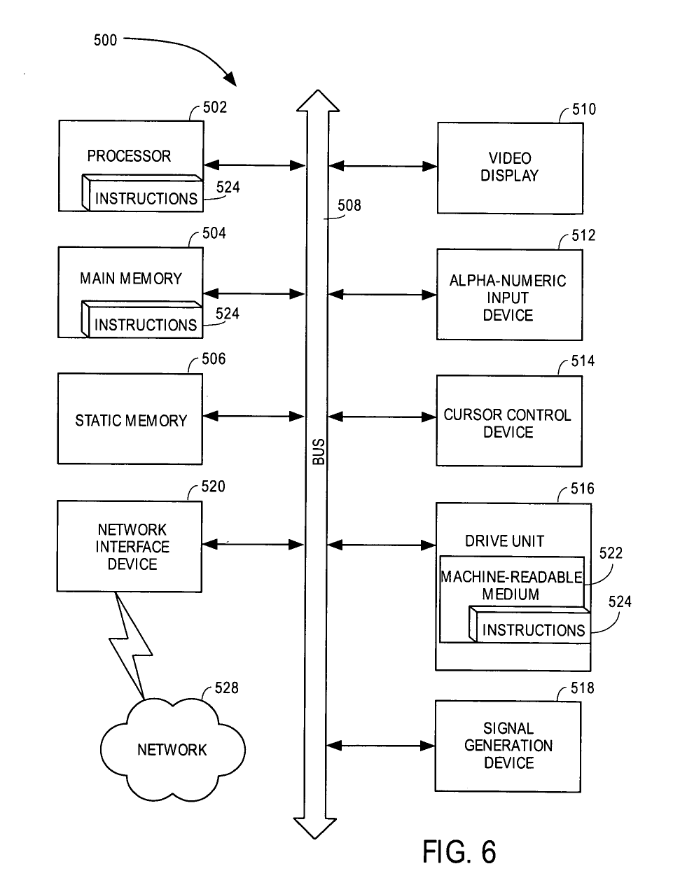

FIG. 6 shows a diagrammatic representation of a machine in the exemplary form of a computer system 500 that may include a microelectronic circuit having the microelectronic structure of FIG. 5. The machine may be a Personal Computer (PC), a tablet PC, a Set-Top Box (STB), a Personal Digital Assistant (PDA), a cellular telephone, a web appliance, a network router, a switch or bridge, or any machine capable of executing a set of instructions that specify actions to be taken by that machine.

Exemplary computer system 500 includes a processor 502, a main memory 504, and a static memory 506, which communicate with each other via a bus 508.

The computer system 500 may further include a video display 501. The computer system 500 also includes an alpha-numeric input device 512 (e.g., a keyboard), a cursor control device 514 (e.g., a mouse), a disk drive unit 516, a signal generation device 518 (e.g., a speaker), and a network interface device 520.

The described unit includes a machine-readable medium 522 on which is stored one or more sets of instructions 524 (e.g., software). The software may also reside, completely or at least partially, within the main memory 504 and/or within the processor 502 during execution thereof by the computer system 500, the main memory 504 and the processor 502 also constituting machine-readable media.

The software may further be transmitted or received via a network 528 via the network interface device 520.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings, and the appended claims without departing from the spirit of the invention. In addition to variations and modifications in the component parts and/or arrangements, alternative uses may also be apparent to those skilled in the art.

Furthermore, for ease of understanding, certain functional blocks may have been delineated as separate blocks; however, these separate delineated blocks should not necessarily be construed as being in the order in which they are discussed or otherwise represented herein. For example, some blocks may be able to be performed in an alternative ordering, simultaneously, etc.

What is claimed:

1. A method of processing a substrate, comprising:
applying a coupling agent and a metal ion solution to the substrate;
applying an activating solution to activate metal ions of the metal ion solution to create a metal film out of the ions; and
applying a metal base solution, metal from the metal film catalyzing metal of the base metal solution to form a layer out of the metal of the metal base solution.

2. The method of claim 1, further comprising cleaning the substrate to functionalize OH-groups of the substrate, the coupling agent attaching to the OH-groups.

3. The method of claim 2, further comprising rinsing the substrate with water.

4. The method of claim 1, wherein the coupling agent is an amino silane.

5. The method of claim 4, wherein the ions are Pd+ ions.

6. The method of claim 1, wherein the metal of the metal base solution is Cu.

7. The method of claim 1, wherein the coupling agent is applied at a temperature of between 50° C. and 70° C.

8. The method of claim 1, wherein the activating solution is hypophosphorus acid or dimethylamine borane.

9. The method of claim 1, wherein the activating solution is applied at a temperature of between 50° C. and 70° C.

10. The method of claim 1, wherein the metal base solution is applied at a temperature of between 50° C. and 70° C.

11. The method of claim 1, further comprising annealing the coupling agent and the layer to remove the coupling agent.

12. The method of claim 11, wherein the metal film is annealed at a temperature of below 350° C.

13. The method of claim 1, further comprising:
forming a trench in the substrate;
forming a barrier layer on a base and on sidewalls of the trench, wherein the layer is a metal seed layer formed on the barrier layers; and
plating a metal structure on the seed layer.

14. The method of claim 13, wherein the seed layer and the metal structure are of the same metal.

15. A microelectronic structure, comprising:
a substrate; and
a layer on the substrate, the layer including atoms and a metal, the atoms being of a material selected to catalyze the metal, and the atoms forming no more than an atomic layer thickness of the layer.

16. The microelectronic structure of claim 15, wherein the atoms are Pd and the metal is Cu.

17. The microelectronic structure of claim 15, wherein the layer is between 1 nm and 10 nm thick.

18. A microelectronic structure, comprising:
a substrate having a trench formed therein;
a barrier layer formed on a base and on side walls of the trench;
a seed layer formed on the barrier layer, the seed layer including atoms and a metal, the atoms being of a material selected to catalyze the metal; and
a metal structure plated on the seed layer.

19. The microelectronic structure of claim 18, further comprising a processor, the metal structure forming part of the processor.

20. The microelectronic structure of claim 19, wherein the metal of the seed layer and the metal structure are of the same metal.
